(19) United States
(12) Patent Application Publication
(10) Pub. No.: US 2026/0050980 A1
(43) Pub. Date: Feb. 19, 2026

(54) PERFORMING RISK ASSESSMENTS BASED ON INFLATION MODELING

(71) Applicant: Wells Fargo Bank, N.A., San Francisco, CA (US)

(72) Inventors: Orcan Ogetbil, Astoria, NY (US); Bernhard Hientzsch, Jericho, NY (US)

(21) Appl. No.: 18/805,138

(22) Filed: Aug. 14, 2024

(51) Int. Cl. G06Q 40/06

(52) U.S. Cl. CPC G06Q 40/06

(57) ABSTRACT

This disclosure describes an inflation model that can be used to perform risk estimation on a portfolio of assets. In one example, this disclosure describes a method that includes collecting, by a computing system, information about risk exposures associated with an organization having a risk policy; applying, by the computing system, a forward inflation index model to the information about the risk exposures, wherein the forward inflation index model has a multifactor volatility structure; determining, by the computing system and based on applying the forward inflation index model to the information about the risk exposures, a plurality of risk assessments; and taking action, by the computing system and based on the risk assessments, to cause another computing system to perform an operation to implement the risk policy.

### TECHNICAL FIELD

This disclosure relates to computing systems, and more specifically, to techniques for using computing systems to model inflation and perform operations based on the modeling.

### BACKGROUND

The general increase in the prices of goods and services in an economy is referred as inflation. Inflation is usually measured by some form of consumer price index, which may be a weighted average of a selected set of goods and services. As inflation has direct impact on purchasing power it constitutes an investment risk, which can be mitigated by inflation-linked securities. The global increase in annual inflation over the past decade has been accompanied by growth in demand for such securities.

### SUMMARY

This disclosure describes an inflation model that can be used to perform risk estimation on a portfolio of assets. The inflation model described herein may be implemented as a multifactor model capable of accurately modeling correlations between different tenors observed in the market. The inflation model may also be extended with leverage functions to more accurately capture market volatility skew. This disclosure also describes a computing system taking actions based on risk assessments that are based on use of the inflation model, where the actions may include controlling other computing systems to perform operations to implement an organizational risk policy.

In some examples, this disclosure describes operations performed by a computing system in accordance with one or more aspects of this disclosure. In one specific example, this disclosure describes a method comprising collecting, by a computing system, information about risk exposures associated with an organization having a risk policy; applying, by the computing system, a forward inflation index model to the information about the risk exposures, wherein the forward inflation index model has a multifactor volatility structure; determining, by the computing system and based on applying the forward inflation index model to the information about the risk exposures, a plurality of risk assessments; and taking action, by the computing system and based on the risk assessments, to cause another computing system to perform an operation to implement the risk policy.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

This summary is intended to provide a brief overview of some of the subject matter described in this document. Accordingly, the above-described features are merely examples and should not be construed to narrow the scope or spirit of the subject matter described herein. Other features, objects, and advantages of the disclosure will be apparent from the description and drawings, and from the claims.

### BRIEF DESCRIPTION OF THE DRAWINGS

FIG. 1 is a conceptual diagram illustrating an example system for performing risk assessments and taking actions based on the risk assessments, in accordance with one or more aspects of the present disclosure.

FIG. 2 is a block diagram illustrating an example system for performing risk assessments and taking actions based on the risk assessments, in accordance with one or more aspects of the present disclosure.

FIG. 3 illustrates a comparison of correlations implied by two and three factor inflation models to historical market correlations.

FIG. 4A illustrates Market and Monte Carlo implied volatilities for a leveraged inflation model.

FIG. 4B illustrates Market and Monte Carlo implied volatilities for a simplified inflation model.

FIG. 5A compares the Monte Carlo prices for the leveraged inflation model to analytical prices.

FIG. 5B compares the Monte Carlo prices for the simplified inflation model to analytical prices.

FIG. 6 is a flow diagram illustrating operations performed by an example computing system in accordance with one or more aspects of the present disclosure, in accordance with one or more aspects of the present disclosure.

### DETAILED DESCRIPTION

Organizations that own, manage, or otherwise control large portfolios, such as banks or other financial institutions, often perform assessments to estimate counterparty credit risk, traded market risk, and other types of risk that may pertain to the portfolio. In some cases, particularly for organizations such as large financial institutions, certain risk assessments may need to be performed and/or reported to the appropriate entity. Such risk assessments may involve credit valuation adjustments and debit valuation adjustments relating to counterparties and trading partners involved in the organization's portfolio. Such assessments may provide information about the impact that a default of one or more of the counterparties would have on the organization's holdings, trades, or financial position. Such assessments may also provide information about the impact that the organization's default may have on its counterparties and trading partners.

This disclosure outlines a forward inflation index model that can be used for performing risk estimation on a portfolio of assets. Relatively simple inflation models are known, and such models can be used for performing pricing estimations and for other purposes. However, relatively simple models are often not suitable for properly performing risk estimation. For example, a complex asset portfolio may include a variety of diverse instruments, each of which may have various interest rate components and/or dependencies. To model risk in a systematic and consistent manner for such a portfolio, an appropriate inflation model would preferably model interest rates consistently across many types of instruments. A model that is too simplistic would not be adequate for this purpose.

Also, simple models typically do not accurately model correlations between different tenors observed in the market. For example, simple inflation models tend to incorrectly assume that instruments, tenors, and option spaces are highly correlated, and will therefore tend to overestimate counterparty credit risk and other risk measures. Further, simple models tend to ignore the effects of skew, and will tend to underprice or overprice certain option spaces in the context of extreme market moves and other circumstances. Accordingly, to effectively use an inflation model to perform risk estimation on a complex portfolio of assets, the inflation model should be sufficiently sophisticated.

However, a complex model that models inflation well but is nevertheless too cumbersome, time-consuming, and/or resource-intensive to use is also not well suited to some risk estimation applications. The forward inflation index model described herein models correlation, skew, and other attributes effectively, while still being efficient and convenient to use. The disclosed model can be used for risk estimation for a complex portfolio of assets, and can also be used when performing exposure computations, including credit valuation adjustments, debit valuation adjustments, funding valuation adjustments, evaluation potential future exposures, and other valuation adjustments. Such a model can provide significant advantages in terms of not only accuracy and speed, but also in terms of computational and human capital resource requirements.

The model described herein may also reduce an organization's need to perform certain calculations and engage in complex computational processes, such as by enabling the organization to take advantage of certain conventions that streamline and/or simplify certain risk assessments (e.g., assessments made for reporting purposes). For example, an organization that has a counterparty or trading partner with whom the organization has mutual risk exposures for a diverse set of instruments (e.g., commodities, interest rate swaps, or other instruments) might perform a risk assessment for each different type of instrument. Such risk assessments may be performed by the organization for business or planning purposes, or, in some cases, to satisfy risk requirements. However, with a sufficiently sophisticated forward inflation index model, it may be possible to more conveniently perform those risk assessments. In addition, in some situations, an organization may be able to take advantage of certain netting processes or conventions, enabling an organization to treat (pursuant to an appropriate “netting set” arrangement) each of the transactions the organization engages in with that counterparty in the same or a similar manner, even where those transactions may involve different types of instruments. Such practices may have a number of benefits, which may include a reduction in the burdens of complying with the organization's risk obligations.

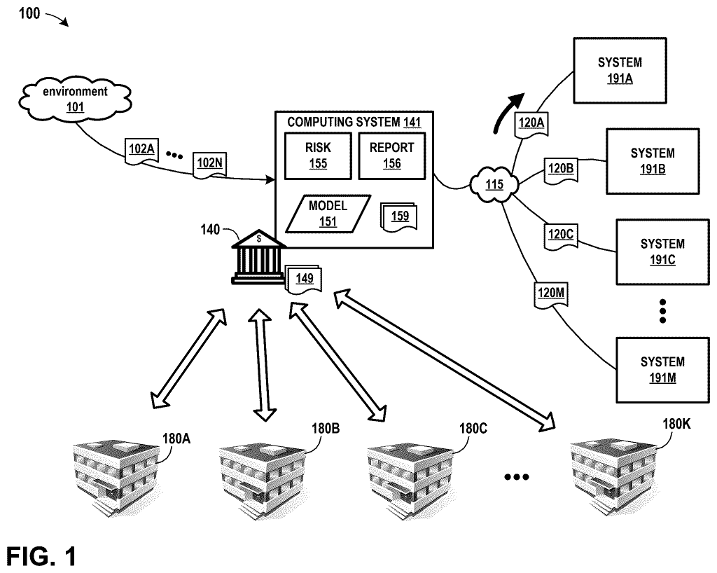

FIG. 1 is a conceptual diagram illustrating an example system for performing risk assessments and taking actions based on the risk assessments. System 100 of FIG. 1 includes computing system 141, network 115, and systems 191A through 191M (“systems 191”). Computing system 141 includes inflation model 151, risk assessment system 155, and reporting system 156. Computing system 141 is capable of communicating with each of systems 191 over network 115. As described herein, computing system 141 may control, over network 115, one or more of systems 191A through 191M, where such control causes a given system 191 to perform operations as directed by computing system 141. Computing system 141 may perform such control through corresponding control signals 120A through 120M. Although computing system 141 is illustrated as interacting primarily with systems 191 over network 115, computing system 141 may interact with other systems over network 115 or with other systems over other networks.

Computing system 141 may be owned, controlled, and/or operated by organization 140. In at least some examples described herein, organization 140 is a bank or other financial institution, particularly a large bank having risk obligations and a large portfolio of diverse assets. For example, organization 140 may hold various futures, commodities, or foreign exchange positions, or may hold options on commodities or other assets through an exchange or clearinghouse or through private contracts. Organization 140 may also own various equity, real estate, bond, cryptocurrency, or other assets.

Organization 140 may also have contractual, trading, and/or other relationships with one or more counterparties 180 (i.e., counterparties 180A through 180K), as indicated by arrows between organization 140 and each of counterparties 180. In one example, organization 140 and counterparty 180A may each be a party to a derivative contract, such as an inflation or interest rate swap or other arrangement. Organization 140 and counterparty 180A may have other trading, contractual, or competitive relationships. Similarly, organization 140 may have similar relationships with each of counterparties 180B through 180K. Accordingly, assets or positions held by organization 140 may depend to some extent on one or more of counterparties 180, and such assets or positions may be subject to certain risk exposures 149. Although organization 140 may be described herein as a bank or other financial institution, techniques described herein may be applicable to other types of organizations, and in general, to any organization seeking to model inflation for a portfolio of assets.

Computing system 141 may receive a continuous or periodic series of environment data 102 (e.g., environment data 102A through 102N) representing information about the context or world in which organization 140 operates, generally referred to as environment 101. Such environment data 102 may include information that is relevant to the value of at least some aspects of the portfolio held by organization 140. Environment data 102 may include any appropriate or relevant information about the environment 101, which may include market conditions, interest rates, changes to interest rates, rate volatility, inflation levels, commodities prices, commodities volatility, equity market information (including information about prices, price changes, and market volatility), and any other information that may affect the values of assets held by organization 140. Such data may also include information about one or more counterparties 180, which may provide some indications about default risk associated with one or more of counterparties 180. Such data may also include information that may pertain to the credit risk of organization 140, such as information about positions held or trading exposures associated with various risk exposures 149 associated with organization 140. In general, environment data 102 may encompass any relevant data about news, events, conditions, or other information that may be relevant in some way to the positions held by organization 140 or to the portfolio of assets owned, controlled, or managed by organization 140.

Each asset in the organization's portfolio of assets may have one or more corresponding risk exposures 149, where each such risk exposure 149 represents a potential loss or exposure due to changes in inflation, market values, government policy, economic conditions, counterparty solvency, or any other contingency, potential loss, or event. In FIG. 1, computing system 141 may apply inflation model 151 to the portfolio in light of environment data 102.

Risk assessment system 155 of computing system 141 may, based on applying inflation model 151, generate a set of risk assessments 159. One or more of risk assessments 159 may pertain to each of risk exposures 149. Based on the risk assessments 159, risk assessment system 155 of computing system 141 may cause reporting system 156 to generate data. Alternatively, or in addition, risk assessment system 155 may, based on risk assessments 159, interact with or control one or more of systems 191.

In FIG. 1, at least some of systems 191 may be external systems, meaning that such systems are not owned, operated, or under administrative control of organization 140. For example, system 191A may be a market exchange computing system that computing system 141 may interact with to adjust, modify, or initiate an investment or market position. System 191B may be another type of computing system operated by a third party, such as a trading partner, an advisor, a regulatory body, counterparty, or other entity. Although systems 191A and 191B might not be under administrative control of computing system 141 (or organization 140), computing system 141 may nevertheless be able to control at least some aspects of systems 191A or 191B through control signals 120A or 120B.

In some examples, however, one or more of systems 191 may be considered internal systems that are owned, controlled, and/or operated by organization 140. For example, system 191C may be an internal system that may be capable of performing actions within organization 140 to mitigate, manage, respond to, or estimate risk. System 191C might also be a reporting system or data store for storing data about assets held by 140, which may include information about risk exposures 149, counterparties 180, or environment data 102. And in general, system 191M may be any appropriate system, whether internal or external, that may be used in some way to take an action in response to various risk assessments 159 generated by computing system 141 using model 151.

Systems illustrated in FIG. 1 (e.g., computing system 141, risk assessment system 155, reporting system 156, systems 191) may be implemented as any suitable computing system, including one or more server computers, workstations, mainframes, appliances, cloud computing systems, and/or other computing devices that may be capable of performing operations and/or functions described in accordance with one or more aspects of the present disclosure. In some examples, each such system may represent or be implemented through one or more virtualized compute instances (e.g., virtual machines, containers) of a data center, cloud computing system, server farm, and/or server cluster. In these or other examples, such computing systems may be accessible over a network as a web service, website, or other service platform. Further, although each of the described computing systems are primarily illustrated as separate and distinct from other computing systems, some or all aspects of any of the illustrated computing systems may be incorporated into another computing system.

In operation, computing system 141 may collect and/or maintain information about potential risk exposures that may apply to organization 140. For instance, in an example that can be described in the context of FIG. 1, risk assessment system 155 of computing system 141 collects information about a portfolio of assets owned, controlled, or managed by organization 140. Specifically, risk assessment system 155 accesses (e.g., from a data store maintained by organization 140) information about each of the assets, positions, contracts, trades, financial relationships, or other direct or indirect interests that organization 140 may own, manage, or control, which may include assets, trades, and/or contractual relationships with each of counterparties 180. Risk assessment system 155 evaluates the accessed information. Such an evaluation may involve an assessment of trading positions, holdings, and/or agreements between organization 140 and each of counterparties 180. Risk assessment system 155 also evaluates new agreements, relationships, or changes to existing agreements between organization 140 and counterparties 180. Based on the evaluation, risk assessment system 155 identifies one or more risk exposures 149 that may apply to organization 140. Each of risk exposures 149 may apply to one or more specific assets owned or managed by organization 140 and/or may apply to one or more of counterparties 180.

Computing system 141 may model the effect of inflation scenarios on risk exposures 149. For instance, continuing with the example being described in connection with FIG. 1, risk assessment system 155 outputs information about risk exposures 149 to inflation model 151. Inflation model 151 performs modeling functions, which may include modeling various inflation scenarios on each of risk exposures 149, on subsets of risk exposures 149, or on all of risk exposures 149. Inflation model 151 outputs information about the modeling to risk assessment system 155. Risk assessment system 155 uses this information to generate one or more risk assessments 159 with respect to organization 140 and risk exposures 149, and/or with respect to one or more of counterparties 180.

Computing system 141 may continue to evaluate risk exposures 149. For instance, still continuing with the example being described in the context of FIG. 1, risk assessment system 155 receives a stream or series of environment data 102. Risk assessment system 155 evaluates the received environment data 102 and determines the extent to which environment data 102 may affect or impact one or more of risk exposures 149. In making such determinations, risk assessment system 155 may output information about environment data 102 to inflation model 151. Inflation model 151 may use the information about environment data 102 to update its modeling of various inflation scenarios in light of the new information about environment 101, as reflected by environment data 102. Inflation model 151 outputs information about the updated modeling to risk assessment system 155. Risk assessment system 155 uses the information about the updated modeling to update its risk assessments 159 and/or to generate new risk assessments 159 with respect to organization 140 and risk exposures 149, and/or with respect to one or more of counterparties 180. Risk assessment system 155 may, for example, determine that environment data 102 suggests that one or more risk exposures 149 have increased such that the risk assessments for those risk exposures 149 indicate that the risk profile for organization 140 has become less favorable for those risk exposures 149. Alternatively, or in addition, risk assessment system 155 may determine that some environment data 102 suggests that other risk exposures 149 have decreased, so that the risk assessments for those other risk exposures 149 indicate that the risk profile for organization 140 has become more favorable.

Computing system 141 may take action based on the updated risk modeling. For instance, again with reference to FIG. 1, risk assessment system 155 determines that, based on the updated risk assessments 159, organization 140 can more effectively guard against risk and/or protect its assets by modifying its positions, holdings, relationships, or other aspects of its portfolio. Alternatively, or in addition, risk assessment system 155 determines that, based on the updated risk assessments 159, organization 140 can more effectively take advantage of opportunities identified by those risk assessments by modifying its positions, holdings, relationships, or other aspects of its portfolio. In general, risk assessment system 155 may determine a set of actions that may achieve or implement one or more policies established by organization 140. In some cases, those policies identify a level or type of risk that the organization is willing to bear or withstand. In other cases, those policies may identify the types of opportunities that the organization will seek to use for its portfolios. Implementing such policies may involve modifying positions and/or taking actions with respect to the assets in the portfolio owned, managed, or controlled by organization 140.

In one example, to implement an organizational risk policy, risk assessment system 155 may cause system 191A to perform an action on behalf of organization 140. Specifically, risk assessment system 155 outputs control signals 120A to an external system 191A, instructing system 191A to perform an operation, such as modifying trading positions relating to one or more of risk exposures 149. In this example, system 191A is an external system that is not owned or under administrative control by organization 140, and may be a trading exchange system, a computing system at a trading desk or on a trading floor, a distributed ledger or blockchain, a computing system at a brokerage or commercial partner, or any other computing system that may enable 140 to modify its positions, holdings, relationships, or other aspects of one or more of risk exposures 149. Control signals 120A may therefore cause system 191A to execute a trade, adjust or hedge an existing position, initiate a new position, place contingent orders that may execute based on a future event, report relevant information, or comply with risk requirements. Such actions may involve other operations, which may include creating or modifying data (e.g., ledger entries, accounting adjustments, blockchain entries, exchange orders).

In another example, risk assessment system 155 outputs control signals 120C to an internal system 191C instructing system 191C to perform an action to implement a policy of organization 140. In this example, system 191C is an internal system that is owned, operated, and/or under administrative control of organization 140. Accordingly, system 191C may be an internal exchange, a private or dark trading pool, or any other internal order matching system operated by organization 140. System 191C may also be a trading desk or computing system on a trading floor operated by organization 140, a distributed ledger maintained by organization 140, an internal reporting system, a system operated by one or more risk assessment personnel or model valuation personnel, a system that communicates with regulators or other systems, or any other type of internal system. Control signals 120C may cause system 191C to execute a contract, initiate a trade, adjust or hedge an existing position, initiate a new position, or place contingent orders, report relevant information, or enable internal risk assessment personnel to evaluate aspects of one or more of risk exposures 149.

And in general, risk assessment system 155 may output control signal 120M to system 191M instructing system 191M to perform an action on to carry out a risk policy (or other policy) of organization 140. Accordingly, system 191M may be any other type of system (internal or external relative to organization 140) that risk assessment system 155 may interact with to perform an operation, cause an action to occur, or communicate information about risk exposures 149 that may apply to organization 140. System 191M may be a reporting system that logs information about risk exposures 149 held by organization 140. System 191M may be operated by a regulator or an oversight entity, where such system 191M is configured to enable computing system 141 or risk assessment system 155 to use control signals 120M to update regulatory, compliance, or other information within records or a data store included within system 191M. In other examples, system 191M may be a system owned or controlled by one or more of counterparties 180, where one or more of such counterparties 180 might be (or might not be) trading partners with respect to one or more of risk exposure 149. As described, risk assessment system 155 is capable of controlling, by interacting with system(s) 191 and based on risk assessments 159, the operation of another computer system to thereby cause that other computing system to take tangible actions within system 100 on behalf of organization 140.

Further information relating to modeling and concepts related to those disclosed herein are published in Ogetbil & Hientzsch, “Inflation Models with Correlation and Skew,” May 2024 (available at https://doi.org/10.48550/arXiv.2405.05101), and Ogetbil & Hientzsch, “Extensions of Dupire Formula: Stochastic Interest Rates and Stochastic Local Volatility,” SIAM Journal on Financial Mathematics 14(2):452-474, 2023. Both of these publications are hereby incorporated by reference.

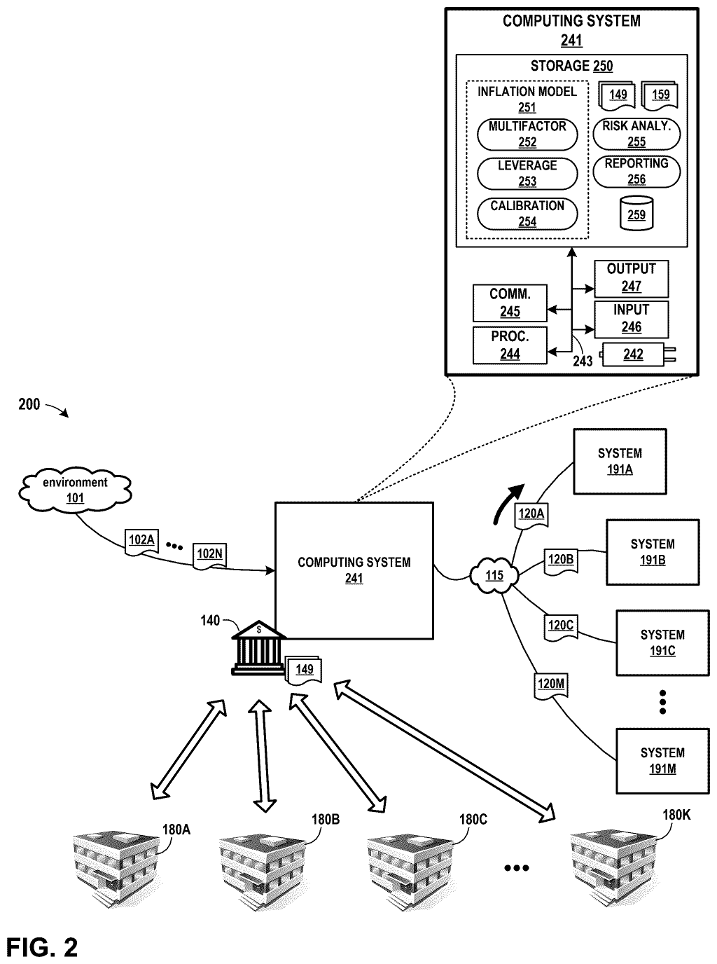

FIG. 2 is a block diagram illustrating an example system for performing risk assessments and taking actions based on the risk assessments. System 200 of FIG. 2 includes many of the same elements of system 100 described in connection with FIG. 1. Elements illustrated in FIG. 2 may correspond to earlier-described elements sharing the same reference numeral.

Also illustrated in FIG. 2 is computing system 241, which may be considered an example or alternative implementation of computing system 141 of FIG. 1. Computing system 241 is illustrated in FIG. 2 to facilitate a description of certain components, modules, and other aspects of a computing system that may implement a system for modeling inflation and/or performing risk estimation, such as computing system 141. Computing system 241 is also illustrated in FIG. 2 to facilitate a description of how such a computing system may operate in accordance with techniques described herein.

For ease of illustration, computing system 241 is depicted in FIG. 2 as a single computing system. However, in other examples, computing system 241 may be implemented through multiple devices or computing systems distributed across a data center, multiple data centers, multiple cloud networks, or otherwise. For example, separate computing systems may implement functionality described herein as being performed by each of various modules of computing system 241, including inflation model 251, risk analysis module 255, and reporting module 256. Alternatively, or in addition, modules illustrated in FIG. 2 as included within computing system 241 may be implemented through distributed virtualized compute instances (e.g., virtual machines, containers) of a data center, cloud computing system, server farm, and/or server cluster.

In FIG. 2, computing system 241 is shown with underlying physical hardware that includes power source 242, one or more processors 244, one or more communication units 245, one or more input devices 246, one or more output devices 247, and one or more storage devices 250. Storage devices 250 may include inflation model 251, risk analysis module 255, reporting module 256, and data store 259.

One or more processors 244 of computing system 241 may implement functionality and/or execute instructions associated with computing system 241 or associated with one or more modules illustrated herein and/or described herein. One or more processors 244 may be, may be part of, and/or may include processing circuitry that performs operations in accordance with one or more aspects of the present disclosure.

One or more communication units 245 of computing system 241 may communicate with devices external to computing system 241 by transmitting and/or receiving data, and may operate, in some respects, as both an input device and an output device. In some or all cases, one or more communication units 245 may communicate with other devices or computing systems over a network.

One or more input devices 246 may represent any input devices of computing system 241, and one or more output devices 247 may represent any output devices of computing system 241. Input devices 246 and/or output devices 247 may generate, receive, and/or process output from any type of device capable of outputting information to a human or machine. For example, one or more input devices 246 may generate, receive, and/or process input in the form of electrical, physical, audio, image, and/or visual input (e.g., peripheral device, keyboard, microphone, camera). Correspondingly, one or more output devices 247 may generate, receive, and/or process output in the form of electrical and/or physical output (e.g., peripheral device, actuator).

One or more storage devices 250 within computing system 241 may store information for processing during operation of computing system 241. Storage devices 250 may store program instructions and/or data associated with one or more of the modules described in accordance with one or more aspects of this disclosure. One or more processors 244 and one or more storage devices 250 may provide an operating environment or platform for such modules, which may be implemented as software, but may in some examples include any combination of hardware, firmware, and software. One or more processors 244 may execute instructions and one or more storage devices 250 may store instructions and/or data of one or more modules. The combination of processors 244 and storage devices 250 may retrieve, store, and/or execute the instructions and/or data of one or more applications, modules, or software. Processors 244 and/or storage devices 250 may also be operably coupled to one or more other software and/or hardware components, including, but not limited to, one or more of the components of computing system 241 and/or one or more devices or systems illustrated or described as being connected to computing system 241.

Inflation model 251 may perform functions relating to evaluating risk exposures 149 and modeling the effects of various scenarios, market conditions, and circumstances on one or more of risk exposure 149. In FIG. 2, inflation model 251 includes multifactor module 252, leverage module 253, and calibration module 254. In some examples, inflation model 251 may accurately model correlation and skew, such as in the manner described below. Specifically, multifactor module 252 may implement or apply a Principal Component Analysis to establish inflation model 251 or when determining the number of factors that should be used for inflation model 251. Leverage module 253 may be responsible for implementation of leverage functions to extend the inflation model 251 to effectively capture and/or model market volatility skew. Calibration module 254 may be capable of calibrating model 251, such as by calibrating one or more of the leverage functions used by leverage module 253. In general, inflation model 251 may perform functions corresponding to those performed by inflation model 151 of FIG. 1.

Risk analysis module 255 may perform functions relating to evaluating the modeling performed by inflation model 251 based on risk exposures 149 and generating risk assessments 159. Risk analysis module 255 may also be responsible for causing one or more of systems 191 to take actions in response to risk assessments 159. Risk analysis module 255 may perform functions generally corresponding to those performed by risk assessment system 155 of FIG. 1.

Reporting module 256 may perform various reporting functions relating to risk assessments 159. In some examples, reporting module 256 may log data about various risk assessments 159 and generate information for consumption by risk assessment personnel associated with or employed by organization 140. In other examples, reporting module 256 may generate information for reporting to any of counterparties 180 pursuant to an agreement between organization 140 and such a counterparty 180, or to any other entity or organization, as may be appropriate. Reporting module 256 may perform functions corresponding to those performed by reporting system 156 of FIG. 1.

Internal data store 259 of computing system 241 may represent any suitable data structure or storage medium for storing information relating to environment data 102, risk exposures 149, risk assessment 159, or data used to generate risk assessments 159. The information stored in internal data store 259 may be searchable and/or categorized such that one or more modules within computing system 241 may provide an input requesting information from internal data store 259, and in response to the input, receive information stored within internal data store 259. Internal data store 259 may be primarily maintained by risk analysis module 255.

Power source 242 of computing system 241 may provide power to one or more components of computing system 241. Power source 242 may receive power from an alternating current (AC) power supply in a building, data center, or other location. In some examples, power source 242 may be or include a battery or a device that supplies direct current (DC). Power source 242 may have intelligent power management or consumption capabilities, and such features may be controlled, accessed, or adjusted by processors 244 to intelligently consume, allocate, supply, or otherwise manage power.

One or more of the devices, modules, storage areas, or other components of computing system 241 may be interconnected to enable inter-component communications (physically, communicatively, and/or operatively). In some examples, such connectivity may be provided by through communication channels, which may include a system bus (e.g., communication channel 243), a network connection, an inter-process communication data structure, or any other method for communicating data. Although computing system 241 of FIG. 2 may be considered an example implementation of computing system 141 of FIG. 1, other implementations are possible.

In operation, and in accordance with one or more aspects of the present disclosure, computing system 241 may collect and/or maintain information about risk exposures 149. For instance, in an example that can be described in the context of FIG. 2, risk analysis module 255 of computing system 241 outputs a series of queries to internal data store 259. In response to the queries, risk analysis module 255 receives from internal data store 259 information about assets held by organization 140, trading positions held by organization 140, relationships between organization 140 and each of counterparties 180 that are relevant to those trading positions or otherwise, and other information about potential risks to any of the assets or positions held by organization 140. Based on the information received from internal data store 259, risk analysis module 255 identifies a set of risk exposures 149 that apply to or are associated with organization 140.

Computing system 241 may model the effect of inflation scenarios on assets held by 140 and/or risk exposures 149. For instance, again with reference to FIG. 2, risk analysis module 255 outputs information about one or more risk exposures 149 to inflation model 251. Inflation model 251 receives the information about risk exposures 149 and applies a forward inflation index model to the information about the risk exposures 149. Specifically, inflation model 251 may apply a multifactor model implemented through processes performed by multifactor module 252 to model the effect of inflation scenarios on various risk exposures 149 held by organization 140. In performing such modeling, leverage module 253 of inflation model 251 may accurately model skew. In addition, inflation model 251 may also, as described below, calibrate one or more leverage functions for each underlying factor in the multifactor inflation model. However, also as discussed below, leverage module 253 may be able to avoid calibration of the leverage functions by ignoring certain terms in the appropriate Dupire equations.

Before describing inflation modeling in accordance with the techniques of this disclosure, it may be appropriate to furnish the base environment with a short rate process by which we can compute bond prices. Let [symbol] be a Brownian motion under risk-neutral measure [symbol] of filtered probability space (Ω, F, {Fₜ, t≥0}, [symbol] ). We assume that the numeraire associated with the risk-neutral measure [symbol] , that is the money market account B(t), accrues at short rate r(t) by dB(t)=r(t)B(t)dt. The short rate is modeled by a Gaussian single factor process,

$${r}_{t} = {x}_{t} + {ϕ}_{t} , d {x}_{t} = - {a}_{t} {x}_{t} d t + {σ}_{t}^{r} d {W}_{t}^{ℚ ( r )} .$$

Here ϕₜ is the shift function that is calibrated to market discount curve, aₜ≥0 are the mean reversion coefficients,

$${σ}_{t}^{r} > 0$$

are the volatility coefficients, and x₀=0. The discount factor is given by

$$D ( t ) ≡ 1 / B ( t ) = exp [ - {\int }_{0}^{t} r ( u ) d u ] .$$

We denote by

$$P ( t , T ) ≡ {E}^{ℚ} [ \frac{D ( T )}{D ( t )} \vert {F}_{t} ]$$

the time t value of the zero coupon bond maturing at time T, through which we define the instantaneous forward rate

$$f ( t , T ) ≡ - \frac{\partial log P ( t , T )}{\partial T} = - \frac{1}{P ( t , T )} \frac{\partial P ( t , T )}{\partial T} .$$

Under the T-forward measure [symbol] ^{T} defined by the numeraire P(t,T), the short rate process evolves as

$$d {x}_{t} = [ - {a}_{t} {x}_{t} - b ( t , T ) {( {σ}_{t}^{r} )}^{2} ] d t + {σ}_{t}^{r} d {W}_{t}^{{ℙ}^{T} ( r )} , \\ with \\ b ( t , T ) ≡ {\int }_{t}^{T} {e}^{- {\int }_{t}^{v} {a}_{z} d z} d v .$$

Here [symbol] is a Brownian motion under the T-forward measure [symbol] ^{T}, and it is related to W^{Q(r)} by

$$d {W}_{t}^{{ℙ}^{T} ( r )} = d {W}_{t}^{ℚ ( r )} + b ( t , T ) {σ}_{t}^{r} d t .$$

Using Itô's lemma one can write the stochastic differential equations (“SDEs”) for the zero coupon bond and the instantaneous forward rate in the risk neutral measure as

$$\frac{d P ( t , T )}{P ( t , T )} = {r}_{t} d t - b ( t , T ) {σ}_{t}^{r} d {W}_{t}^{ℚ ( r )} , d f ( t , T ) = b ( t , T ) \frac{\partial b ( t , T )}{\partial T} {( {σ}_{t}^{r} )}^{2} d t + \frac{\partial b ( t , T )}{\partial T} {σ}_{t}^{r} d {W}_{t}^{ℚ ( r )} ,$$

and in the T-forward measure [symbol] ^{T} as

$$\frac{d P ( t , T}{P ( t , T )} = [ {r}_{t} + {( b ( t , T ) {σ}_{t}^{r} )}^{2} ] d t - b ( t , T ) {σ}_{t}^{r} d {W}_{t}^{{ℙ}^{T} ( r )} , d f ( t , T ) = \frac{\partial b ( t , T )}{\partial T} {σ}_{t}^{r} d {W}_{t}^{{ℙ}^{T} ( r )} .$$

The above zero coupon bond price is solved as

$$\frac{P ( t , T )}{P ( 0 , T )} = exp [ {\int }_{0}^{t} ( {r}_{s} + \frac{1}{2} {( b ( s , T ) {σ}_{s}^{r} )}^{2} ) d s - {\int }_{0}^{t} b ( s , T ) {σ}_{s}^{r} d {W}_{s}^{{ℙ}^{T} ( r )} ] ,$$

where P(0,T) is the time-zero market value of the zero coupon bond P(t,T). The time t value of the zero coupon bond price can be written as

$$P ( t , T ) = exp [ - {\int }_{t}^{T} ( {ϕ}_{s} - \frac{1}{2} {( b ( s , T ) {σ}_{s}^{r} )}^{2} ) d s - b ( t , T ) {x}_{t} ]$$

Given a set of time-zero discount factors P(0, T₁), . . . , P(0, T_{N}) at times T₁, . . . , T_{N} and model parameters aₜ,

$${σ}_{t}^{r} ,$$

one can compute the shift function with

$${ϕ}_{{T}_{n}} = \frac{1}{{T}_{n} - {T}_{n - 1}} log \frac{{P}^{z} ( 0 , {T}_{n} ) P ( 0 , {T}_{n - 1} )}{{P}^{z} ( 0 , {T}_{n - 1} ) P ( 0 , {T}_{n} )} , \\ where \\ {P}^{z} ( t , T ) = exp [ \frac{1}{2} {\int }_{t}^{T} {( b ( s , T ) {σ}_{s}^{r} )}^{2} d s - b ( t , T ) {x}_{t} ] .$$

Consider a new zero coupon bond P(t, T̅) maturing at time T̅, with associated T̅-forward measure [symbol] ^{T}. The Radon-Nikodym derivative reads

$$\frac{d {ℙ}^{\overline{T}}}{d {ℙ}^{T}} = \frac{P ( t , T ) P ( 0 , \overline{T} )}{P ( t , \overline{T} ) P ( 0 , T )} .$$

Plugging in the earlier equation, this derivative becomes

$$\frac{d {ℙ}^{\overline{T}}}{d {ℙ}^{T}} = exp [ {\int }_{0}^{t} - \frac{1}{2} {( {σ}_{s}^{r} )}^{2} ( {b}^{2} ( s , \overline{T} ) - {b}^{2} ( s , T ) ) ds - {\int }_{0}^{t} {σ}_{s}^{r} b ( s , \overline{T} ) d {W}_{s}^{{ℙ}^{T} ( r )} + {\int }_{0}^{t} {σ}_{s}^{r} b ( s , T ) d {W}_{s}^{{ℙ}^{T} ( r )} ] .$$

By Girsanov theorem, one sees that

$$d {W}_{t}^{{ℙ}^{\overline{T}} ( r )} = d {W}_{t}^{{ℙ}^{T} ( r )} + {σ}_{t}^{r} ( b ( t , \overline{T} ) - b ( t , T ) ) dt$$

is a Brownian motion under [symbol] ^{T}.

Let us denote by I(t) the CPI at time t. Consider a single payment fixed-float swap on the CPI. The forward CPI F(t; T, \tilde{T}) is defined as the fixed amount to be set at T and exchanged at time \tilde{T} so that the swap has zero value at time t.

$$F ( t ; T , \tilde{T} ) = {E}^{{ℙ}^{\tilde{T}}} [ I ( T ) \vert {F}_{t} ] .$$

We define inflation linked zero coupon bond in terms of the nominal bond P(t, \tilde{T}) and the forward CPI rate F(t; T, \tilde{T}) as

$${P}_{I L} ( t , \tilde{T} ) ≡ P ( t , \tilde{T} ) \cdot F ( t ; T , \tilde{T} ) .$$

CPI values are announced at times Tᵢ=T₀, T₁, . . . , T_{I}. In Kazziha model, the dynamics for Fᵢ(t)≡F(t; Tᵢ, \tilde{T}ᵢ) are specified by the single-factor log-normal process

$$\frac{d {F}_{i} ( t )}{{F}_{i} ( t )} = {σ}_{i} d {W}_{t}^{{ℙ}^{{\tilde{T}}_{i}} ( F )}$$

where [symbol] is a Brownian motion under the \tilde{T}ᵢ-forward measure [symbol] ^{\tilde{T}}^{ᵢ} with numéraire P(t, \tilde{T}ᵢ).

To price derivatives involving two or more forward CPIs, a common measure is often used. For this purpose, it may be appropriate to consider a nominal zero coupon bond P(t, Tₚ) of maturity Tₚ. Under the measure associated with P(t, Tₚ), the CPI process generally has nonzero drift,

$$\frac{d {F}_{i} ( t )}{{F}_{i} ( t )} = {μ}_{i} ( t ) d t + {σ}_{i} d {W}_{t}^{{ℙ}^{{T}_{p}} ( F )} .$$

Let ρ_{rF} be the coefficient of correlation between the Brownian motions [symbol] and

$${W}^{{ℙ}^{{T}_{p}} ( F )} is {ρ}_{r F} = \frac{d}{dt} {〈 {W}^{{ℙ}^{{T}_{p}} ( r )} , {W}^{{ℙ}^{{T}_{p}} ( F )} 〉}_{t} .$$

Using an earlier equation and Lemma A.1 of, we find that under [symbol] ^{T}^{ₚ} the CPI process follows

$$\frac{d {F}_{i} ( t )}{{F}_{i} ( t )} = - {ρ}_{r F} {σ}_{i} {σ}_{t}^{r} ( b ( t , {T}_{p} ) - b ( t , {\tilde{T}}_{i} ) ) d t + {σ}_{i} d {W}_{t}^{{ℙ}^{{T}_{p}} ( F )} ,$$

so that

$${μ}_{i} ( t ) = - {ρ}_{r F} {σ}_{i} {σ}_{t}^{r} ( b ( t , {T}_{p} ) - b ( t , {\tilde{T}}_{i} ) ) .$$

One can use the above SDEs to compute the expectation of the forward CPI as

$${E}^{{ℙ}^{{T}_{p}}} [ {F}_{i} ( {T}_{i} ) \vert {F}_{t} ] = {F}_{i} ( t ) {e}^{{\int }_{t}^{{T}_{i}} {μ}_{i} ( s ) ds} .$$

Applying the shift in the Brownian motion in the reverse direction to an earlier SDE, or setting Tₚ=b(t, Tₚ)=0 in another equation above, we obtain the evolution of the CPI process in risk neutral measure

$$\frac{d {F}_{i} ( t )}{{F}_{i} ( t )} = {ρ}_{r F} {σ}_{i} {σ}_{t}^{r} b ( t , {\tilde{T}}_{i} ) d t + {σ}_{i} d {W}_{t}^{ℚ ( F )} .$$

Zero-coupon swaps, caps and floors are the most standard exchange traded instruments. The general swap(let) has a single payoff at time \tilde{T}ᵢ, that depends on the inflation rate set at time Tᵢ as

$${Swap}_{i} = \overline{N} \cdot [ \frac{I ( {T}_{i} )}{\overline{I}} - {( 1 + \overline{K} )}^{\overline{T}} ] ,$$

where N̅ is the notional amount, Ī is the reference rate, K̅ is the compounded strike, and T̅ is the tenor as contractual quantities. Defining

$$N ≡ \frac{\overline{N}}{\overline{I}} ,$$

and K≡Ī(1+K̅)^{\tilde{T}}, the payoff can be written as

$${Swap}_{i} ( K , {\tilde{T}}_{i} , {T}_{i} , {\tilde{T}}_{i} ) = N ( I ( {T}_{i} ) - K ) .$$

The time t value of this swap can be evaluated analytically as

$$\begin{matrix}{Swap}_{i} ( K , t , {T}_{i} , {\tilde{T}}_{i} ) = N \cdot P ( t , {\tilde{T}}_{i} ) \cdot {E}^{{ℙ}^{{\tilde{T}}_{i}}} [ I ( {T}_{i} ) - K \vert {F}_{t} ] \\ N \cdot P ( t , {\tilde{T}}_{i} ) \cdot [ {F}_{i} ( t ) - K ]\end{matrix} .$$

The cap(let) and the floor(let) have a single payoff at time \tilde{T}ᵢ, that depends on the capped/floored CPI rate set at time Tᵢ as

$${Cap}_{i} ( K , {\tilde{T}}_{i} , {T}_{i} , {\tilde{T}}_{i} ) = N \cdot {[ I ( {T}_{i} ) - K ]}^{+} ,$$

$${Floor}_{i} ( K , {\tilde{T}}_{i} , {T}_{i} , {\tilde{T}}_{i} ) = N \cdot {[ K - I ( {T}_{i} ) ]}^{+} .$$

where the quantities are as defined for the zero coupon swap. The time t value of the cap and the floor are given by

$$\begin{matrix}{Cap}_{i} ( K , t , {T}_{i} , {\tilde{T}}_{i} ) = N \cdot P ( t , {\tilde{T}}_{i} ) \cdot {E}^{{ℙ}^{{\tilde{T}}_{i}}} [ {( I ( {T}_{i} ) - K )}^{+} \vert {F}_{t} ] , \\ = N \cdot P ( t , {\tilde{T}}_{i} ) \cdot [ {F}_{i} ( t ) Φ ( {d}_{1} ) - K Φ ( {d}_{2} ) ]\end{matrix} ,$$

$$\begin{matrix}{Floor}_{i} ( K , t , {T}_{i} , {\tilde{T}}_{i} ) = N \cdot P ( t , {\tilde{T}}_{i} ) \cdot {E}^{{ℙ}^{{\tilde{T}}_{i}}} [ {( K - I ( {T}_{i} ) )}^{+} \vert {F}_{t} ] . \\ = N \cdot P ( t , {\tilde{T}}_{i} ) \cdot [ K Φ ( - {d}_{2} ) - {F}_{i} ( t ) Φ ( - {d}_{1} ) ]\end{matrix} ,$$

where

$${d}_{1} ≡ \frac{1}{{σ}_{i} \sqrt{{τ}_{i}}} log ( \frac{{F}_{i} ( t )}{K} ) + \frac{{σ}_{i} \sqrt{{τ}_{i}}}{2} ,$$

d₂ ≡d₁−σ\sqrt{iτᵢ}, τᵢ≡Tᵢ−t, Φ(⋅) is the cumulative Gaussian probability distribution, the Kazziha parameter τᵢ corresponds to the market volatility Σᵢ(K) for strike K and maturity Tᵢ, and the zero coupon bond price P(t, \tilde{T}ᵢ) is given in an equation above.

The year-on-year inflation swap(let) has a single payoff at time Tₚ, that depends on the inflation rates set at time Tᵢ and Tⱼ, with t<Tᵢ<Tⱼ<Tₚ as

$${YOYSwap}_{i} ( K , {T}_{p} , {T}_{i} , {T}_{j} , {T}_{p} ) = N \cdot [ \frac{I ( {T}_{j} )}{I ( {T}_{i} )} - ( 1 + {\overline{K}}_{Y} ) ] ,$$

where N is the notional amount, and K̅_{γ} is the strike as contractual quantities. Tⱼ is Tᵢ plus one year. The time t value of this swap is given by

$$\begin{matrix}{YOYSwap}_{i} ( K , t , {T}_{i} , {T}_{j} , {T}_{p} ) = N \cdot P ( t , {T}_{p} ) \cdot {E}^{{ℙ}^{T} p} [ \frac{I ( {T}_{j} )}{I ( {T}_{i} )} - {K}_{Y} \vert {F}_{t} ] \\ = N \cdot P ( t , {T}_{p} ) \cdot [ {X}_{ij} ( t ) - {K}_{Y} ] ,\end{matrix}$$

with K_{γ}≡1+K̅_{γ}. The expectation of the forward ratio

$${X}_{ij} ( t ) ≡ {E}^{{ℙ}^{{T}_{p}}} [ \frac{I ( {T}_{j} )}{I ( {T}_{i} )} \vert {F}_{t} ]$$

is calculated as

$${X}_{ij} ( t ) = \frac{{F}_{j} ( t )}{{F}_{i} ( t )} exp [ {\int }_{t}^{{T}_{j}} {σ}_{j} {\overline{v}}_{j} ( s ) ds - {\int }_{t}^{{T}_{i}} {σ}_{i} {\overline{v}}_{i} ( s ) d s - ( {σ}_{i} {σ}_{j} + {σ}_{i}^{2} ) ( {T}_{i} - t ) ] ,$$

$$and$$

$${\overline{v}}_{i} ( t ) ≡ {ρ}_{rF} {σ}_{t}^{r} ( b ( t , {\tilde{T}}_{i} ) - b ( t , {T}_{p} ) ) .$$

The year-on-year cap(let) and the floor(let) have a single payoff at time Tₚ, that depends on the capped/floored inflation rates set at times Tᵢ and Tⱼ as

$${YOYCap}_{i} ( {K}_{Y} , {T}_{p} , {T}_{i} , {T}_{j} , {T}_{p} ) = N \cdot {[ \frac{I ( {T}_{j} )}{I ( {T}_{i} )} - {K}_{Y} ]}^{+} ,$$

$${YOYFloor}_{i} ( {K}_{Y} , {T}_{p} , {T}_{i} , {T}_{j} , {T}_{p} ) = N \cdot {[ {K}_{Y} - \frac{I ( {T}_{j} )}{I ( {T}_{i} )} ]}^{+} ,$$

where the quantities are as defined for the year-on-year swap. The time t value of the cap and the floor are computed analytically as

$$\begin{matrix}{YOYCap}_{i} ( {K}_{Y} , t , {T}_{i} , {T}_{j} , {T}_{p} ) = N \cdot P ( t , {T}_{p} ) \cdot {E}^{{ℙ}^{T} p} [ {( \frac{I ( {T}_{j} )}{I ( {T}_{i} )} - {K}_{Y} )}^{+} \vert {F}_{t} ] , \\ N \cdot P ( t , {T}_{p} ) \cdot [ {X}_{ij} ( t ) Φ ( {d}_{1} ) - {K}_{Y} Φ ( {d}_{2} ) ] ,\end{matrix}$$

$$\begin{matrix}{YOYFloor}_{i} ( {K}_{Y} , t , {T}_{i} , {T}_{j} , {T}_{p} ) = N \cdot P ( t , {T}_{p} ) \cdot {E}^{{ℙ}^{T} p} [ {( {K}_{Y} - \frac{I ( {T}_{j} )}{I ( {T}_{i} )} )}^{+} \vert {F}_{t} ] . \\ N \cdot P ( t , {T}_{p} ) \cdot [ {K}_{Y} Φ ( - {d}_{2} ) - {X}_{ij} ( t ) Φ ( - {d}_{1} ) ] ,\end{matrix}$$

$$with$$

$${d}_{1} ≡ \frac{log ( \frac{{X}_{ij} ( t )}{{K}_{Y}} )}{\sqrt{{η}_{ij} ( t )}} + \frac{1}{2} \sqrt{{η}_{ij} ( t )} ,$$

$${d}_{2} ≡ {d}_{1} - \sqrt{{η}_{ij} ( t )} ,$$

$${η}_{ij} ( t ) ≡ {σ}_{j}^{2} ( {T}_{j} - t ) + ( {σ}_{i}^{2} - 2 {σ}_{i} {σ}_{j} ) ( {T}_{i} - t ) .$$

A significant drawback of a one factor model is that it is driven by a single Brownian factor, so that it implies perfect correlation of swap rate returns between different maturities. We investigate the number of random factors needed by a model to make it consistent with market correlation behavior by doing principal component analysis (PCA) on the daily changes of swap rates, specifically of Xₖ(t)≡log Fₖ(t) where the index denotes the kth nearest maturity after calendar time t. Based on this analysis, we determined that 71%, 86% and 75% of the variations in curve movements are explained by a single factor for USD, EUR, and GBP respectively. The numbers go over 89%, 97%, and 94% with two factors, and over 95%, 99%, and 98% with three factors.

We also observe that the PCA yielded similar eigenvectors for the three inflation curves considered. The first eigenvector is nearly constant through maturity whereas the second and third eigenvectors contain twists that generate the imperfect correlations. Motivated by this analysis, we decide to formulate a model in \tilde{T}ᵢ-forward measure [symbol] ^{\tilde{T}}^{ᵢ} with M independent random factors [symbol] , α∈{1, . . . , M} and parameters P_{M} to incorporate imperfect market correlations between different maturites in the inflation curve,

$$\frac{{dF}_{i} ( t )}{{F}_{i} ( t )} = {σ}_{i} {\sum }_{α = 1}^{M} {λ}_{i}^{α} ( t ) {dW}_{t}^{{ℙ}^{\tilde{T}} i ( {F}^{α} )} ,$$

with Kazziha parameter σᵢ. For M=1 and λᵢ¹(t)=1 this corresponds to the Kazziha model. For a two factor model setup, M=2, we write

$$\begin{matrix}{λ}_{i}^{1} ( t ) = 1 , \\ {λ}_{i}^{2} ( t ) = {h}_{1} {e}^{- κ ( {T}_{i} - t )} + {h}_{2} ,\end{matrix}$$

with model parameters P₂={h₁, h₂, κ}, and κ>0; and for three factors, M=3, we extend this as

$$\begin{matrix}{λ}_{i}^{1} ( t ) = 1 , \\ {λ}_{i}^{2} ( t ) = {h}_{1} {e}^{- {κ}_{1} ( {T}_{i} - t )} + {h}_{2} , \\ {λ}_{i}^{3} ( t ) = {h}_{3} ( {T}_{i} - t ) {e}^{- {κ}_{2} ( {T}_{i} - t )} + {h}_{4} ,\end{matrix}$$

with model parameters P₃={h₁, h₂, h₃, h₄, κ₁, κ₂}, and κ₁, κ₂>0. The multifactor model implies the following instantaneous correlation at time t between different tenors of the inflation curve,

$${ρ}^{M} ( t , {T}_{i} , {T}_{j} ) = corr ( d log {F}_{i} ( t ) , d log {F}_{j} ( t ) ) = \frac{{ζ}_{ij}^{M} ( t )}{\sqrt{{ζ}_{ii}^{M} ( t ) {ζ}_{jj}^{M} ( t )}} ,$$

where we defined

$${ζ}_{ij}^{M} ( t ) ≡ {\sum }_{α = 1}^{M} {λ}_{i}^{α} ( t ) {λ}_{j}^{α} ( t ) .$$

We note that

$${ζ}_{ij}^{1} ( t ) = 1$$

for the Kazziha model. For a better fit to historical correlation behavior, one can obtain market correlations ρₘₐᵣₖₑₜ(Tⱼ, Tₖ) from historical data series and then minimize the objective function

$$J ( {P}_{M} ) = {\sum }_{j = 0}^{I} {\sum }_{k = j}^{I} {[ {ρ}^{M} ( 0 , {T}_{j} , {T}_{k} ) - {ρ}_{market} ( {T}_{j} , {T}_{k} ) ]}^{2} .$$

Having a set of calibrated parameters P_{M}, σᵢ remains the last parameter to determine. The total variance is computed by integrating the log-variance of the earlier-defined process over the lifetime of the option. Setting the model total implied variance to the variance implied by the market allows the model to produce market prices. In practice, one typically sets σᵢ to match market volatilities Σᵢ; for example at-the-money volatilities, or volatilities corresponding to a target strike,

$${w}_{i}^{M} ( t ) ≡ {\sum }_{i}^{2} ( {T}_{i} - t ) = {σ}_{i}^{2} {\int }_{t}^{{T}_{i}} {ζ}_{ii}^{M} ( s ) ds .$$

The integral on the right hand side can be solved explicitly for the two-factor model above as

$${\int }_{t}^{{T}_{i}} {ζ}_{i i}^{2} ( s ) d s = ( 1 + {h}_{2}^{2} ) {τ}_{i} + \frac{{h}_{1}^{2}}{2 κ} ( 1 - {e}^{- 2 κ {τ}_{i}} ) + \frac{2 {h}_{1} {h}_{2}}{κ} ( 1 - {e}^{- κ {τ}_{i}} ) ,$$

and for the three-factor model above as

$${\int }_{t}^{{T}_{i}} {ζ}_{i i}^{3} ( s ) d s = ( 1 + {h}_{2}^{2} + {h}_{4}^{2} ) {τ}_{i} + \frac{{h}_{1}^{2}}{2 {κ}_{1}} ( 1 - {e}^{- 2 {κ}_{1} {τ}_{i}} ) + \frac{2 {h}_{1} {h}_{2}}{{κ}_{1}} ( 1 - {e}^{- {κ}_{1} {τ}_{i}} ) - \frac{{h}_{3}^{2} {τ}_{i}}{2 {κ}_{2}^{2}} ( {κ}_{2} {τ}_{i} + 1 ) {e}^{- 2 {κ}_{2} {τ}_{i}} - \frac{2 {h}_{3} {h}_{4} {τ}_{i}}{{κ}_{2}} {e}^{- {κ}_{2} {τ}_{i}} + \frac{{h}_{3}^{2}}{4 {κ}_{2}^{3}} ( 1 - {e}^{- 2 {κ}_{2} {τ}_{i}} ) + \frac{2 {h}_{3} {h}_{4}}{{κ}_{2}^{2}} ( 1 - {e}^{- {κ}_{2} {τ}_{i}} ) ,$$

with time to maturity τᵢ ≡Tᵢ−t.

The cap and floor prices have the analytical solutions

$${Cap}_{i} ( K , t , {T}_{i} ) = N \cdot P ( t , {\tilde{T}}_{i} ) \cdot [ {F}_{i} ( t ) Φ ( {d}_{1} ) - K Φ ( {d}_{2} ) ] ,$$

$${Floor}_{i} ( K , t , {T}_{i} ) = N \cdot P ( t , {\tilde{T}}_{i} ) \cdot K Φ ( - {d}_{2} ) - {F}_{i} ( t ) Φ ( - {d}_{1} ) ] , with$$

$${d}_{1} ≡ \frac{log ( \frac{{F}_{i} ( t )}{K} )}{\sqrt{{w}_{i}^{M} ( t )}} + \frac{1}{2} \sqrt{{w}_{i}^{M} ( t )} ,$$

$${d}_{2} ≡ {d}_{1} - \sqrt{{w}_{i}^{M} ( t )} ,$$

The year-on-year cap and floor prices have the analytical solutions

$${YOYCap}_{i} ( {K}_{Y} , t , {T}_{i} , {T}_{j} , {T}_{p} ) = N \cdot P ( t , {T}_{p} ) \cdot [ {X}_{ij} ( t ) Φ ( {d}_{1} ) - {K}_{Y} Φ ( {d}_{2} ) ] ,$$

$${YOYFloor}_{i} ( {K}_{Y} , t , {T}_{i} , {T}_{j} , {T}_{p} ) = N \cdot P ( t , {T}_{p} ) \cdot [ {K}_{Y} Φ ( - {d}_{2} ) - {X}_{ij} ( t ) Φ ( - {d}_{1} ) ] ,$$

$$with$$

$${X}_{ij} ( t ) ≡ \frac{{F}_{j} ( t )}{{F}_{i} ( t )} exp [ {\int }_{t}^{{T}_{j}} {σ}_{j} {\overline{v}}_{j}^{M} ( s ) ds - {\int }_{t}^{{T}_{i}} ( {σ}_{i} {\overline{v}}_{i}^{M} ( s ) - {σ}_{i} {σ}_{j} {ζ}_{ij}^{M} ( s ) - {σ}_{i}^{2} {ζ}_{ii}^{M} ( s ) ) ds ] ,$$

$${d}_{1} ≡ \frac{log ( \frac{{X}_{ij} ( t )}{{K}_{Y}} )}{\sqrt{{η}_{ij}^{M} ( t )}} + \frac{1}{2} \sqrt{{η}_{ij}^{M} ( t )} ,$$

$${d}_{2} ≡ {d}_{1} - \sqrt{{η}_{ij}^{M} ( t )} ,$$

$${\overline{v}}_{i}^{M} ( t ) ≡ {σ}_{t}^{r} ( b ( t , {\tilde{T}}_{i} ) - b ( t , {T}_{p} ) ) {\sum }_{α = 1}^{M} {ρ}_{r} {F}^{α} {λ}_{i}^{α} ( t ) .$$

The implied variance

$${η}_{i j}^{M} ( t )$$

of the year-on-year forward ratio can be written in terms of model parameters as

$$\begin{matrix}{η}_{i j}^{M} ( t ) ≡ {\int }_{c}^{{T}_{j}} {σ}_{j}^{2} {ζ}_{j j}^{M} ( s ) d s + {\int }_{t}^{{T}_{i}} ( {σ}_{i}^{2} {ζ}_{i i}^{M} ( s ) - 2 {σ}_{i} {σ}_{j} {ζ}_{i j}^{M} ( s ) ) d s . \\ = {w}_{j}^{M} ( t ) + {w}_{i}^{M} ( t ) - 2 {σ}_{i} {σ}_{j} {\int }_{t}^{{T}_{i}} {ζ}_{i j}^{M} ( s ) d s .\end{matrix}$$

In the ideal case broker quotes are available for options on the year-on-year forward ratio

$$\frac{I ( {T}_{j} )}{I ( {T}_{i} )} ,$$

one can calibrate the model parameters σᵢ to fit the quotes. In the absence of such quotes, once can use the σᵢs from regular cap-floors. In this case, however, the moneyness to choose for each individual underlier Fᵢ(t) and Fⱼ(t) will have significant impact on the year-on-year price.

Before moving on we write down the evolution of the multi-factor model in the risk neutral measure [symbol] as

$$\frac{d {F}_{i} ( t )}{{F}_{i} ( t )} = {σ}_{i} {v}_{i}^{M} ( t ) d t + {σ}_{i} {\sum }_{a = 1}^{M} {λ}_{i}^{a} ( t ) d {W}_{t}^{ℚ ( {F}^{α} )} , where$$

$${v}_{i}^{M} ( t ) ≡ {σ}_{t}^{r} b ( t , {\tilde{T}}_{i} ) {\sum }_{α = 1}^{M} {ρ}_{r {F}^{α}} {λ}_{i}^{α} ( t ) .$$

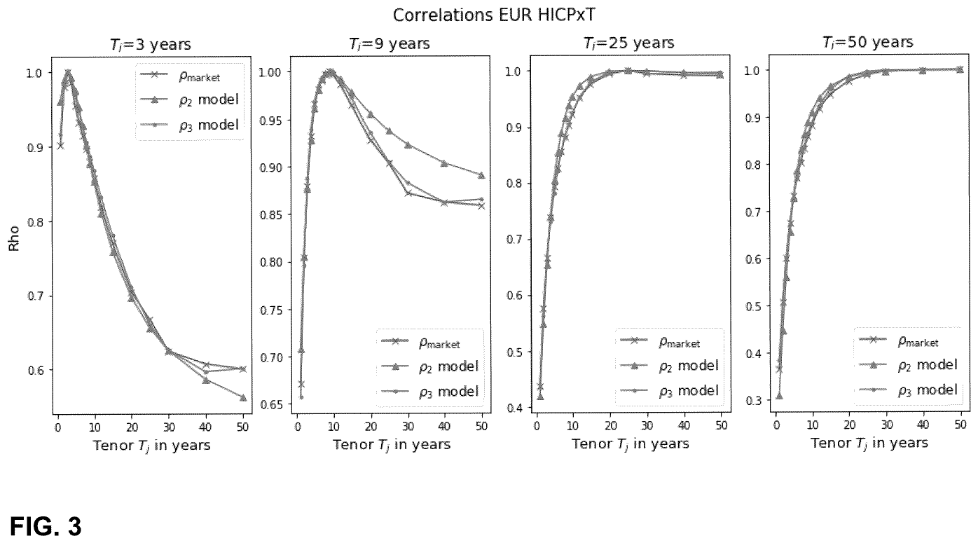

We can calibrate the two and three factor models to historical data using scipy's L-BFGS-B optimizer on the objective function given above. FIG. 3 is an illustration comparing the correlations implied by the two and three factor models to historical market correlations. The two factor model seems to capture most of the historical market correlation behavior, and evidently the three factor model provides some additional improvement. For the two factor model the best fitting parameters are found to be P_2={h_1,h_2,κ}={−3.689, 3.553, 0.042}, whereas for the three factor model they are P_3={h_1,h_2,h_3,h_4,κ_1,κ_2}={2.319, −2.068, 0.275, −0.145, 0.085, 0.142}.

The first of the two tables below lists the market quotes for the volatilities at various tenors and strikes for EUR inflation index HICPxT as of 2023 Apr. 28. The volatility factors σ_i are calculated by using at-the-money (K⁻=0) market volatilities and are listed in the second table below.

K̅

| Tᵢ | Fᵢ(0) | −0.02 | −0.01 | 0.00 | 0.01 | 0.02 | 0.03 | 0.04 | 0.05 |
|---|---|---|---|---|---|---|---|---|---|
| 1 | 124.43 | 3.101% | 2.756% | 2.442% | 2.189% | 1.974% | 1.839% | 1.841% | 1.969% |
| 2 | 127.26 | 2.523% | 2.242% | 1.987% | 1.781% | 1.409% | 1.293% | 1.587% | 1.971% |
| 5 | 136.30 | 3.620% | 3.218% | 2.851% | 2.556% | 2.243% | 2.415% | 2.915% | 3.471% |
| 7 | 142.97 | 4.152% | 3.691% | 3.270% | 2.931% | 2.755% | 2.986% | 3.466% | 4.005% |
| 10 | 153.93 | 4.991% | 4.437% | 3.931% | 3.523% | 3.493% | 3.789% | 4.273% | 4.817% |
| 12 | 162.04 | 5.494% | 4.884% | 4.327% | 3.878% | 3.929% | 4.253% | 4.735% | 5.273% |
| 15 | 175.83 | 6.043% | 5.371% | 4.759% | 4.265% | 4.393% | 4.735% | 5.206% | 5.729% |
| 20 | 201.50 | 7.102% | 6.313% | 5.593% | 5.013% | 5.203% | 5.548% | 6.008% | 6.525% |

| | σᵢ | | |
|---|---|---|---|
| Tᵢ (years) | M = 1 | M = 2 | M = 3 |
| 1 | 0.02925 | 0.02916 | 0.02404 |
| 2 | 0.02178 | 0.02170 | 0.01952 |
| 5 | 0.02961 | 0.02836 | 0.02595 |
| 7 | 0.03360 | 0.03070 | 0.02795 |
| 10 | 0.04007 | 0.03363 | 0.03091 |
| 12 | 0.04396 | 0.03477 | 0.03245 |
| 15 | 0.04820 | 0.03496 | 0.03357 |
| 20 | 0.05647 | 0.03598 | 0.03634 |

The multi-factor model we introduced above aims to capture cross-tenor correlations as well as market volatilities for a target strike. In order to capture the market volatility smile, that is to reprice market quotes of different strikes, we extend the mode with unique leverage functions Lᵢ for each tenor,

$$\frac{d {F}_{i} ( t )}{{F}_{i} ( t )} = {L}_{i} ( {F}_{i} ( t ) , t ) {\sum }_{α = 1}^{M} {λ}_{i}^{α} ( t ) d {W}_{t}^{{ℙ}^{\tilde{T}} i ( {F}^{α} )} .$$

This model evolves in the risk neutral measure [symbol] as

$$\frac{d {F}_{i} ( t )}{{F}_{i} ( t )} = {v}_{i}^{M} ( t ) {L}_{i} ( {F}_{i} ( t ) , t ) dt + {L}_{i} ( {F}_{i} ( t ) , t ) {\sum }_{α = 1}^{M} {λ}_{i}^{α} ( t ) d {W}_{t}^{ℚ ( {F}^{α} )} ,$$

where

$${v}_{i}^{M} ( t )$$

is defined as in an earlier equation. The leverage functions are to be calibrated to market quotes. They are related to time-zero prices of T-maturity cap(let)s paying at time \tilde{T}ᵢ≥T by the Dupire equation,

$${{L}_{i} ( K , T )}^{2} = \frac{\frac{\partial {Cap}_{i} ( K , 0 , T , \tilde{{T}_{i}} )}{\partial T} + {θ}_{i}^{Cap} ( K , T )}{\frac{1}{2} {K}^{2} \frac{{\partial }^{2} {Cap}_{i} ( K , 0 , T , \tilde{{T}_{i} )}}{\partial {K}^{2}} {ζ}_{ii}^{M} ( T )} , where$$

$${θ}_{i}^{Cap} ( K , T ) ≡ {NE}^{ℚ} [ D ( {\tilde{T}}_{i} ) \{ [ {F}_{i} ( T ) - K ] {r}_{T} + {v}_{i}^{M} ( T ) {L}_{i} ( {F}_{i} ( T ) , T ) {F}_{i} ( T ) \} {𝕝}_{{F}_{i} ( T ) > K} ] - f ( 0 , T ) {Cap}_{i} ( K , 0 , T , {\tilde{T}}_{i} ) .$$

In terms of floor(let)s with an above-defined payoff, the leverage functions are,

$${{L}_{i} ( K , T )}^{2} = \frac{\frac{\partial {Floor}_{i} ( K , 0 , T , \tilde{{T}_{i}} )}{\partial T} + {θ}_{i}^{Floor} ( K , T )}{\frac{1}{2} {K}^{2} \frac{{\partial }^{2} {Floor}_{i} ( K , 0 , T , \tilde{{T}_{i} )}}{\partial {K}^{2}} {ζ}_{ii}^{M} ( T )} , where$$

$${θ}_{i}^{Floor} ( K , T ) ≡ {NE}^{ℚ} [ D ( {\tilde{T}}_{i} ) \{ [ K - {F}_{i} ( T ) ] {r}_{T} + {v}_{i}^{M} ( T ) {L}_{i} ( {F}_{i} ( T ) , T ) {F}_{i} ( T ) \} {𝕝}_{{F}_{i} ( T ) < K} ] - f ( 0 , T ) {Floor}_{i} ( K , 0 , T , {\tilde{T}}_{i} ) .$$

The time-zero price function for a time-T maturity caplet with underlier Fᵢ that pays at time \tilde{T}ᵢ can be parametrized in terms of log-moneyness

$$y = log \frac{K}{{F}_{i} ( 0 )}$$

and the total implied variance wᵢ as

$${Cap}_{i} ( y , {w}_{i} ) = NP ( 0 , {\tilde{T}}_{i} ) {F}_{i} ( 0 ) [ Φ ( {d}_{1} ) - {e}^{y} Φ ( {d}_{2} ) ]$$

where

$${d}_{1} = - {yw}_{i}^{- \frac{1}{2}} + \frac{1}{2} {w}_{i}^{\frac{1}{2}} , and {d}_{2} = {d}_{1} - {w}_{i}^{\frac{1}{2}} .$$

In the total implied variance parametrization, the Dupire equation can be casted to L̅ᵢ(y, T)=Li(Fᵢ(0)e^{y}, T) as

$${{\overline{L}}_{i} ( y , T )}^{2} = \frac{\frac{\partial {Cap}_{i}}{\partial {w}_{i}} \frac{\partial {w}_{i}}{\partial T} + {θ}_{i}^{Cap} ( {F}_{i} ( 0 ) {e}^{y} , T )}{\frac{\partial {Cap}_{i}}{\partial {w}_{i}} [ 1 - \frac{y}{{w}_{i}} \frac{\partial {w}_{i}}{\partial y} + \frac{1}{2} \frac{{\partial }^{2} {w}_{i}}{\partial {y}^{2}} + \frac{1}{4} {( \frac{\partial {w}_{i}}{\partial y} )}^{2} ( - \frac{1}{4} - \frac{1}{{w}_{i}} + \frac{{y}^{2}}{{w}_{i}^{2}} ) ] {ζ}_{ii}^{M} ( T )} ,$$

$$with$$

$$\frac{\partial {Cap}_{i}}{\partial {w}_{i}} = \frac{1}{2} NP ( 0 , {\tilde{T}}_{i} ) {F}_{i} ( 0 ) {e}^{y} {Φ}^{′} ( {d}_{2} ) {w}_{i}^{- \frac{1}{2}} .$$

Similarly, the time-zero price function for a time-T maturity floorlet underlier Fᵢ that pays at time \tilde{T}ᵢ can be parametrized as

$${Floor}_{i} ( y , {w}_{i} ) = NP ( 0 , {\tilde{T}}_{i} ) {F}_{i} ( 0 ) [ - Φ ( - {d}_{1} ) + {e}^{y} Φ ( - {d}_{2} ) ] .$$

In the total implied variance parametrization, the Dupire equation becomes

$${{\overline{L}}_{i} ( y , T )}^{2} = \frac{\frac{\partial {Floor}_{i}}{\partial {w}_{i}} \frac{\partial {w}_{i}}{\partial T} + {θ}_{i}^{Floor} ( {F}_{i} ( 0 ) {e}^{y} , T )}{\begin{matrix}\frac{\partial {Floor}_{i}}{\partial {w}_{i}} [ 1 - \frac{y}{{w}_{i}} \frac{\partial {w}_{i}}{\partial y} + \frac{1}{2} \frac{\partial {w}_{i}}{\partial {y}^{2}} + \\ \frac{1}{4} {( \frac{\partial {w}_{i}}{\partial y} )}^{2} ( - \frac{1}{4} - \frac{1}{{w}_{i}} + \frac{{y}^{2}}{{w}_{i}^{2}} ) ] {ζ}_{ii}^{M} ( T )\end{matrix}} ,$$

$$with$$

$$\frac{\partial {Floor}_{i}}{\partial {w}_{i}} = \frac{1}{2} NP ( 0 , {\tilde{T}}_{i} ) {F}_{i} ( 0 ) {e}^{y} {Φ}^{′} ( - {d}_{2} ) {w}_{i}^{- \frac{1}{2}} .$$

In the limit the interest rate volatility

$${σ}_{t}^{r}$$

approaches zero one has

$${v}_{i}^{M} ( t ) = {θ}_{i}^{Cap} = {θ}_{i}^{Floor} = 0 ,$$

and the expression for the leverage function simplifies to

$${{\overline{L}}_{i}^{s} ( y , T )}^{2} = \frac{\frac{\partial {w}_{i}}{\partial T}}{[ 1 - \frac{y}{{w}_{i}} \frac{\partial {w}_{i}}{\partial y} + \frac{1}{2} \frac{\partial {w}_{i}}{\partial {y}^{2}} + \frac{1}{4} {( \frac{\partial {w}_{i}}{\partial y} )}^{2} ( - \frac{1}{4} - \frac{1}{{w}_{i}} + \frac{{y}^{2}}{{w}_{i}^{2}} ) ] {ζ}_{ii}^{M} ( T )} .$$

We use this expression in the calibration routine below for computing the leverage function at time t close to initial time, where the interest rate is observed at a fixed value.

Inflation options traded on the market written on Fᵢ typically have a single maturity Tᵢ. Accordingly, the market implied volatility Σᵢ(K) for strike K yields a total implied variance Σᵢ(K)²Tᵢ at maturity Tᵢ. Here we make the assumption that the total implied variance accumulates linearly in time as wᵢ=Σᵢ(K)²T for times T≤Tᵢ,

$${w}_{i} ( y , T ) = {\sum }_{i} {( {F}_{i} ( 0 ) {e}^{y} )}^{2} T .$$

We adapt the calibration approach proposed in Ogetbil, Ganesan, and Hientzsch, “Calibrating Local Volatility Models with Stochastic Drift and Diffusion,” International Journal of Theoretical and Applied Finance, 25(02):2250011, 2022. arXiv:2009.14764. This publication is hereby incorporated by reference. We use this approach to compute the leverage functions L̅ᵢ for every underlier Fᵢ simultaneously time slice by time slice. We perform a Monte Carlo simulation to estimate the expectation appearing in the expressions for

$${θ}_{i}^{Cap} ( K , T ) and {θ}_{i}^{Floor} ( K , T ) .$$

Our calibration routine expects the following quantities as input for leverage function calibration:
A multi-factor model with parameters calibrated to market data
Market CPI rates Fᵢ(0) as of the valuation time t=0
Market implied volatility Σᵢ(K) for each maturity
Market yield curve P(0, T)
G1++ short rate model (or any rate model for which one can compute the zero-coupon bond price and the measure shift terms) with parameters calibrated to market data.
Coefficients of correlation between the Brownian motions of the short rate and the multi-factor inflation models.

We calibrate the leverage functions time slice by time slice, in a bootstrapping fashion. Let tₖ; k=1, . . . , n be the increasing sequence of (positive) times where we will perform the calibration.
1. Using the market implied volatilities Σᵢ(K)=Σᵢ(Fᵢ(0)e^{y}), generate a total implied variance surface wᵢ(y, T) interpolator. The interpolator must be able to compute the partial derivatives appearing in the local volatility expressions.
2. For the first time slice t₁, evaluate the simplified equation to compute the leverage function values L̅ᵢ(y, t₁) for a predetermined range of strikes for every i. This step requires no Monte Carlo simulation. As a result, obtain leverage function values to be used until time t₂ in the subsequent calibration steps.
3. For each of the subsequent time slices tₖ, k>1, Simulate the SDE system given earlier up to time tₖ. By choosing out-of-money options for a predetermined grid of strikes, that is caps for y>0 and floors for y<0, compute the Monte Carlo estimate for the expectation appearing in the earlier equations for every i. Obtain the leverage function values L̅ᵢ(y, tₖ) from these equations. These values will be used during subsequent simulation steps from time tₖ to time tₖ₊₁. This step is first performed with k=2 and is then repeated for the remaining time slices.

As an example, we calibrate the multifactor model to market data as of Apr. 28, 2023, and use the same multifactor model parameters we estimated above, and the same volatility data provided earlier. For simplicity we ignore the market lag, as is common in the examples in the literature, such that Tᵢ=\tilde{T}ᵢ∀i. The G1++ model parameters are fit to market interest rate swaptions. Here we do not go into details of this fitting. Instead, we list the parameters that we use as input, and refer to earlier works for calibration of Hull-White-type models with time-dependent parameters. G1++ mean reversion is set to be constant, aₜ=0.02. The market discount curve and G1++ volatility parameters are given in the tables below (which list discount factors P(0, T) and G1++ model volatility

$${σ}_{t}^{r}$$

| T (years) | P(0, T) |
|---|---|
| 0 | 1 |
| 1 | 0.9656 |
| 2 | 0.9379 |
| 5 | 0.8706 |
| 7 | 0.8264 |
| 10 | 0.7596 |
| 12 | 0.7152 |
| 15 | 0.6547 |
| 20 | 0.5800 |

| t (years) | σₜ^{r} |
|---|---|
| 1 | 1.071% |
| 2 | 1.093% |
| 3 | 0.992% |
| 5 | 0.839% |
| 10 | 0.686% |
| 20 | 0.683% |

The coefficient of correlation between the Brownian motions [symbol] and [symbol] is

$${ρ}_{{rF}^{α}} = \frac{d}{dt} {〈 {W}^{ℚ ( r )} , {W}^{ℚ ( {F}^{α} )} 〉}_{t} = 0.5 ∀ α .$$

The leverage functions strike grid is chosen to cover regions of concern. In our implementation, we construct a uniform grid for K between −0.02 and 0.05 with spacing 0.001. This is translated to log-moneyness as y=T̅ log(1+K̅) for contractual maturity T̅. It is typically important that the chosen grid is covered by the implied volatility data. For the maturity coordinate we first construct a time grid with uniform spacing, e.g. tₖ₊₁−tₖ=¼ until the latest maturity, and then we add the quoted option maturity times to this grid. The expectation in the leverage equation is estimated by simulating 2000 paths and computing Monte Carlo averages of the argument of the expectation.

We simulate the calibrated model over 2000 paths to price caps at various maturities and strikes. The leverage function values are interpolated piecewise linearly in both dimensions during simulation. We invert the pricing formula to compute the model implied volatilities from the Monte Carlo price means, as well as price means bumped by two Monte Carlo standard errors in both directions.

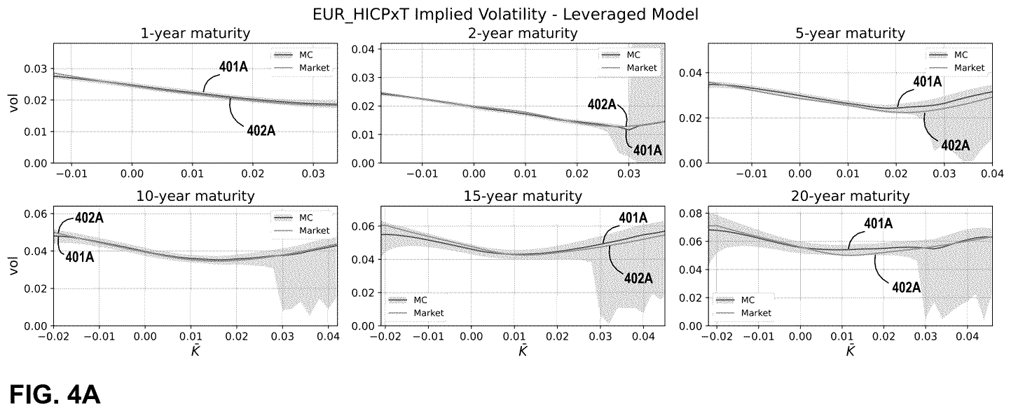

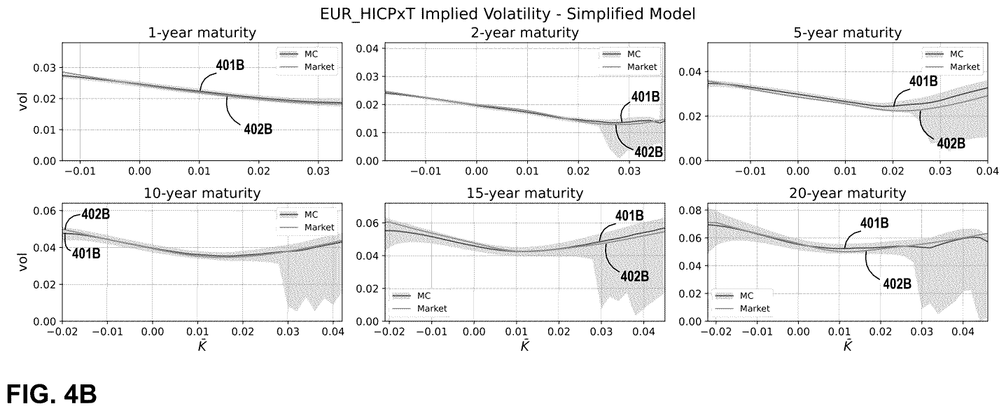

FIG. 4A illustrates market and Monte Carlo implied volatilities for the leveraged model with M=3 factors for EUR inflation as of 2023 Apr. 28. In FIG. 4A, the market implied volatilities are labeled 401A, and the Monte Carlo implied volatilities are labeled 402A. As can be seen in FIG. 4A, the resulting market implied volatilities are within two Monte Carlo errors of the simulation means (shaded regions) for most strikes within the test range. This test demonstrates that the implementation of the leveraged three factor model recovers market quotes at various strikes and maturities.

The leveraged model described above seems to capture the market skew for caps and floors well. The calibration routine of the leverage function, however, involves a Monte Carlo estimation. Here we formulate a simplified model by ignoring negligible terms in the Dupire equation such that the resulting model does not require the calibration step.

We can approximate the leverage function by

$${\overline{L}}_{i} {( y , T )}^{2} \approx {Λ}_{i} {( y , T )}^{2} ≡ \frac{\frac{\partial {w}_{i}}{\partial T}}{{[ 1 - \frac{1}{2} \frac{y}{{w}_{i}} \frac{\partial {w}_{i}}{\partial y} ]}^{2} {ζ}_{ii}^{M} ( T )} .$$

By plugging in an earlier expression for total implied variance, the above equation can be written as

$${Λ}_{i} ( y , T ) = \frac{{q}_{i} ( {F}_{i} ( 0 ) {e}^{y} )}{\sqrt{{ζ}_{ii}^{M} ( T )}} ,$$

$$where$$

$${q}_{i} ( K ) ≡ \frac{{\sum }_{i} ( K )}{1 - \frac{K log \frac{K}{{F}_{i} ( 0 )}}{{\sum }_{i} ( K )} \frac{\partial {\sum }_{i}}{\partial K}} .$$

With this function, we can formulate a simplified multi-factor model as

$$\frac{{dF}_{i} ( t )}{{F}_{i} ( t )} = \frac{{q}_{i} ( {F}_{i} ( t ) )}{\sqrt{{ζ}_{ii}^{M} ( t )}} {\sum }_{α = 1}^{M} {λ}_{i}^{α} ( t ) {dW}_{t}^{{ℙ}^{{\tilde{T}}_{i}} ( {F}^{α} )} .$$

In practice we use an algorithmic cap parameter η for qᵢ(K),

$${q}_{i} ( K ) ≡ \frac{{\sum }_{i} ( K )}{max ( \frac{1}{η} , 1 - \frac{K log \frac{K}{{F}_{i} ( 0 )}}{{\sum }_{i} ( K )} \frac{\partial {\sum }_{i}}{\partial K} )} .$$

Our testing and analysis shows that η=10 is typically a good choice.

As in the previous discussion, we simulate the calibrated model over 2000 paths to price caps at various maturities and strikes. We compute the model implied volatilities from the Monte Carlo prices by inverting the pricing formula.

FIG. 4B illustrates market and Monte Carlo implied volatilities for the simplified model with M=3 factors for EUR inflation as of 2023 Apr. 28. In FIG. 4B, the market implied volatilities are labeled 401B, and the Monte Carlo implied volatilities are labeled 402B. FIG. 4B illustrates that the market implied volatilities are within two Monte Carlo standard errors (shaded regions) for most strikes. Moreover, comparison to FIG. 4A reveals that the simplified model performs similarly to the leveraged model in terms of accuracy.

To provide a pricing example, we can simulate the leveraged model and the simplified model with 3 factors over 2000 paths to price 1-year to 2-year caps for several strikes with a payoff defined in an earlier equation. We compare the Monte Carlo prices to the analytical prices given by equations outlined above. We note that the strike K_{γ} of the year-on-year contract does not directly correspond to the strike K that goes in Σᵢ(K) while calibrating the Kazziha parameter σᵢ to market volatilities for underlier Fᵢ. If regular cap/floor quotes, e.g. Σᵢ(K), are only what is available as market data, one needs to pick a moneyness for the underlier Fᵢ to compute σᵢ. Here we study the impact of this choice by computing analytical prices with K̅ ranging from −0.02 to 0.03, where K=Fᵢ(0)(1+K̅)^{T}^{ᵢ}.

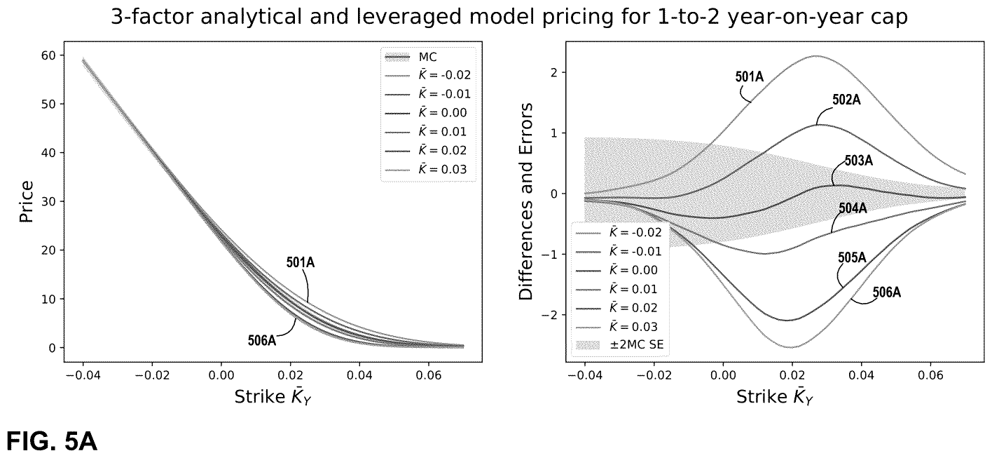

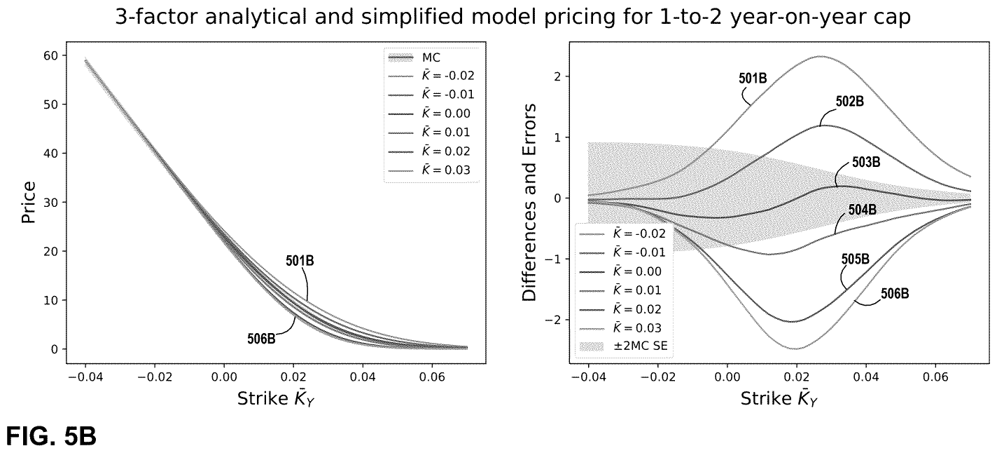

FIG. 5A compares the Monte Carlo prices for the leveraged model to the analytical prices. Similarly, FIG. 5B shows the comparison between the Monte Carlo prices for the simplified model to the analytical prices. In each illustration, the underlier moneyness ranges from −0.02 (501A in FIG. 5A, 501B in FIG. 5B) to +0.03 (506A in FIG. 5A, 506B in FIG. 5B).

The shaded areas denote two standard errors from the Monte Carlo errors from the mean. The first observation is that both the leveraged and the simplified model give similar prices. The second observation is that the analytical model prices vary significantly by the choice of individual underlier moneynesses (K̅) when calibrating the Kazziha parameter σᵢ to market volatilities Σᵢ(K). For both the leveraged and the simplified models, the simulated model prices are close to the analytical prices, that is the differences are within two standard errors for most strikes in the test range, only if we choose the individual underlier moneynesses close to at-the-money (K̅→0) during the analytical price computation.

Referring again to FIG. 2, computing system 241 may perform risk estimation based on the modeled effects of various inflation scenarios. For instance, after modeling the effect of inflation on risk exposures 149, and with reference again to the example being described in connection with to FIG. 2, inflation model 251 outputs information about the modeling to risk analysis module 255. Risk analysis module 255 uses the information to assess or evaluate each of risk exposures 149. Risk analysis module 255 generates one or more risk assessments 159.

Computing system 241 may take action based on risk assessments 159. For instance, continuing with the example, risk analysis module 255 determines, based on risk assessment 159 and organizational policy, an appropriate action to take. In some examples, the action may be performed either to preserve assets or to take advantage of an opportunity to enhance the value of those assets. To perform the action, risk analysis module 255 of inflation model 251 causes communication unit 245 to output one or more control signals 120A over network 115. System 191A detects signals over network 115 and determines that the signals are control signals that can be used to control system 191A and perform an action as directed by risk analysis module 255 of computing system 241. System 191A uses control signals 120A to perform the requested action, thereby implementing a policy of organization 140.

Alternatively, or in addition, risk analysis module 255 causes communication unit 245 to output one or more other control signals 120 over 115 to control the operation of one or more other systems 191. For example, risk analysis module 255 may cause communication unit 245 to output control signals 120B to system 191B, thereby causing system 191B to perform an action requested by risk analysis module 255 of computing system 241. Similarly, risk analysis module 255 may cause communication unit 245 to output control signals 120M to system 191M, thereby causing system 191M to perform an action requested by risk analysis module 255.

Computing system 241 may also generate reporting based on risk assessments 159. For instance, again continuing with the example being described in the context of FIG. 2, risk analysis module 255 of computing system 241 outputs information about risk assessments 159 to reporting module 256. Reporting module 256 uses risk assessments 159 to generate reports about risk exposures, valuation adjustments, credit valuation adjustments, debit valuation adjustments, funding valuation adjustments, potential future exposures, and other information. Reporting module 256 may store information about the reports in internal data store 259. In some examples, reporting module 256 may cause communication unit 245 to output information over network 115 to one or more of systems 191, where such information may be analyzed by a human analyst that performs counterparty credit risk oversight or market risk oversight, or that generates information for submission to the appropriate entity. In some cases, reporting module 256 may generate a report for consumption by such an analyst on a daily basis or pursuant to any other appropriate schedule.

Modules illustrated in FIG. 2 (e.g., inflation model 251, multifactor module 252, leverage module 253, calibration module 254, risk analysis module 255, reporting module 256) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

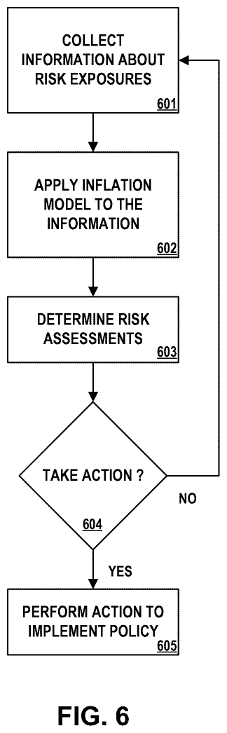

FIG. 6 is a flow diagram illustrating operations performed by an example computing system in accordance with one or more aspects of the present disclosure. FIG. 6 is described below within the context of computing system 241 of FIG. 2. In other examples, operations described in FIG. 6 may be performed by one or more other components, modules, systems, or devices. Further, in other examples, operations described in connection with FIG. 6 may be merged, performed in a difference sequence, omitted, or may encompass additional operations not specifically illustrated or described.

In the process illustrated in FIG. 6, and in accordance with one or more aspects of the present disclosure, computing system 241 may collect information about a set of risk exposures associated with an organization having a risk policy (601). For example, risk analysis module 255 of computing system 241 outputs requests to internal data store 259 for information about assets held by organization 140. Risk analysis module 255 receives responsive information and evaluates the information to determine a set of risk exposure 149. In some examples, communication unit 245 of computing system 241 detects a series of environment data 102. In such examples, risk analysis module 255 may determine how the environment data 102 may affect risk exposures 149.

Computing system 241 may apply an inflation model to the information about the set of risk exposures (602). For example, risk analysis module 255 outputs information about the risk exposures 149 to inflation model 251. Inflation model 251 serves as a forward inflation index model, and performs various modeling operations, modeling the effects of different inflation scenarios on assets held by organization 140, and determining how such scenarios affect risk exposures 149.

Computing systems 241 may determine, based on applying the forward inflation index model to the risk exposures, a plurality of risk assessments (603). For example, inflation model 251 outputs information about the modeling it has performed to risk analysis module 255. Risk analysis module 255 receives the information from inflation model 251 and uses the information to generate risk assessments 159 for each of risk exposures 149.

Computing system 241 may take action, based on the risk assessments, to cause another computing system to perform an operation to implement the risk policy (605). For example, risk analysis module 255 evaluates risk assessments 159 and determines whether any organizational risk policy adopted by organization 140 suggests or mandates that an action be taken based on the risk assessments 159. If a policy suggests or mandates that an action be taken, risk analysis module 255 causes communication unit 245 to output control signals (e.g., control signals 120M) over network 115 to cause one or more of systems 191 (e.g., system 191M) to perform the suggested or mandated action (605 and “YES” path from 604). Otherwise, if no policy suggests or mandates an action to be taken, no action is taken in response to the risk assessments 159 (“NO” path from 604).

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any material that is incorporated by reference conflicts with the present disclosure, the present disclosure shall control.

For ease of illustration, a limited number of devices, computing systems, and other systems are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner. References herein to “real time” or equivalent phrases are intended to encompass near-real time or seemingly near-real time, such as from the perspective of a reasonable human observer.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including, to the extent appropriate, a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
collecting, by a computing system, information about one or more risk exposures associated with an organization having a risk policy;
applying, by the computing system, a forward inflation index model to the information about the risk exposures, wherein the forward inflation index model has a multifactor volatility structure;
determining, by the computing system and based on applying the forward inflation index model to the information about the risk exposures, a plurality of risk assessments; and
taking action, by the computing system and based on the risk assessments, to cause another computing system to perform an operation to implement the risk policy.

2. The method of claim 1, further comprising:
implementing, by the computing system, the multifactor volatility structure for the forward inflation index model using Principal Component Analysis.

3. The method of claim 1, wherein the risk exposures pertain to positions in market instruments having different tenors, and wherein applying the forward inflation index model further comprises:
applying a forward inflation index model configured to model the different tenors of the market instruments.

4. The method of claim 1, wherein applying the forward inflation index model further comprises:
applying a forward inflation index model that uses a plurality of leverage functions to capture market volatility skew.

5. The method of claim 4, wherein applying the forward inflation index model further comprises:
using Dupire formulas to capture the market volatility skew.

6. The method of claim 5, wherein at least some factors in the multifactor inflation index model are each associated with one of the plurality of leverage functions, and wherein the method further comprises:
calibrating, by the computing system, the plurality of leverage functions using a Monte Carlo simulation.

7. The method of claim 1, wherein applying the forward inflation index model further comprises:
applying a forward inflation index model that uses Dupire formulas to capture market volatility skew; and
creating an uncalibrated forward inflation index model by eliminating at least one low order term in the Dupire formulas.

8. The method of claim 1, wherein taking action includes:
sending control signals to an internal system once the plurality of risk assessments have been determined, the control signals instructing the internal system to perform the operation.

9. The method of claim 1, wherein taking action includes:
sending control signals to an external system once the plurality of risk assessments have been determined, the control signals instructing the external system to adjust a position underlying at least one of the risk exposures.

10. The method of claim 1, wherein determining the plurality of risk assessments includes:
determining an effect that a default by a counterparty would have on at least one of the risk exposures associated with the organization.

11. The method of claim 1, wherein the risk exposures pertain to a plurality of trades with a counterparty involving a first type of instrument and a second type of instrument, and wherein determining the plurality of risk assessments includes:
netting exposures for the first type of instrument with exposures for the second type of instrument.

12. A computing system comprising processing circuitry and a storage device, wherein the processing circuitry has access to the storage device and is configured to:
collect information about one or more risk exposures associated with an organization having a risk policy;
apply a forward inflation index model to the information about the risk exposures, wherein the forward inflation index model has a multifactor volatility structure;
determine, based on applying the forward inflation index model to the information about the risk exposures, a plurality of risk assessments; and
take action, based on the risk assessments, to cause another computing system to perform an operation to implement the risk policy.

13. The computing system of claim 12, wherein the processing circuitry is further configured to:
implement the multifactor volatility structure for the forward inflation index model using Principal Component Analysis.

14. The computing system of claim 12, wherein the risk exposures pertain to positions in market instruments having different tenors, and wherein the processing circuitry is further configured to:
apply a forward inflation index model configured to model the different tenors of the market instruments.

15. The computing system of claim 12, wherein the processing circuitry is further configured to:
apply a forward inflation index model that uses a plurality of leverage functions to capture market volatility skew.

16. The computing system of claim 15, wherein to extend the forward inflation index model with the plurality of leverage functions, the processing circuitry is further configured to:
use Dupire formulas to capture the market volatility skew.

17. The computing system of claim 16, wherein at least some factors in the multifactor inflation index model are each associated with one of the plurality of leverage functions, and wherein the processing circuitry is further configured to:
calibrate the plurality of leverage functions using a Monte Carlo simulation.

18. The computing system of claim 12, wherein the processing circuitry is further configured to:
apply a forward inflation index model that uses Dupire formulas to capture market volatility skew; and
create an uncalibrated forward inflation index model by eliminating at least one low order term in the Dupire formulas.

19. The computing system of claim 12, wherein to take action the processing circuitry is further configured to:
send control signals to an internal system once the plurality of risk assessments have been determined, the control signals instructing the internal system to perform the operation.

20. A non-transitory computer-readable medium comprising instructions that, when executed, configure processing circuitry of a computing system to:
collect information about one or more risk exposures associated with an organization having a risk policy;
apply a forward inflation index model to the information about the risk exposures, wherein the forward inflation index model has a multifactor volatility structure;
determine, based on applying the forward inflation index model to the information about the risk exposures, a plurality of risk assessments; and
take action, based on the risk assessments, to cause another computing system to perform an operation to implement the risk policy.
